(19) United States
(12) Patent Application Publication
(10) Pub. No.: US 2013/0208193 A1
(43) Pub. Date: Aug. 15, 2013

(54) MOVING DISPLAY SYSTEM

(71) Applicant: Stephen Wyllie, Bala (CA)

(72) Inventor: Stephen Wyllie, Bala (CA)

(21) Appl. No.: 13/839,874

(22) Filed: Mar. 15, 2013

Related U.S. Application Data
(63) Continuation-in-part of application No. 13/247,487, filed on Sep. 28, 2011.

(30) Foreign Application Priority Data
Sep. 28, 2012 (CA) PCT/CA2012/000903

(51) Int. Cl. G09F 11/22; H04N 5/655

(52) U.S. Cl. CPC G09F 11/22; H04N 5/655
USPC 348/836; 40/466

(57) ABSTRACT

In one aspect, the invention is directed to a moving display system having a track member support; a track member held by the track member support, and having a first end and a second end; a display member support, including a body, where the body is configured to hold a display member, a motor, a wheel, where the wheel is drivable by the motor to move the display member support along the track member, a sensing system including at least one sensor positioned for detecting the first and second ends of the track member and a slot extending through the body for receiving the track member. A control system is provided and is operatively connected to the motor. The control system receives signals from the sensing system and is programmed to, in at least some instances:
a) determine using the signals when the display member support reaches one of the first and second ends of the track member, and
b) change the direction of rotation of the motor based on the determination made in step a).

### CROSS-REFERENCE TO RELATED APPLICATIONS

This application is a continuation-in-part of International Patent Application No. PCT/CA2012/000903 filed Sep. 28, 2012, which claims the benefit of U.S. patent application Ser. No. 13/247,487, filed Sep. 28, 2011, which are both hereby incorporated by reference in their entirety.

### FIELD

The present disclosure relates to moving displays and particularly moving displays for advertising products for sale.

### BACKGROUND

It is known to provide a moving display for the purpose of advertising products or services for sale. However such displays are typically expensive, difficult to install, complex and prone to failure. There is a need for a moving display system that is simple, easy to install, inexpensive, and yet reliable.

### SUMMARY

In one aspect, the invention is directed to a moving display system that includes a track member support, a track member held by the track member support, and having a first end and a second end, and a display member support. The display member support includes a body, wherein the body is configured to hold a display member, a motor, and a wheel that is drivable by the motor to move the display member support along the track member and a sensing system. A control system is provided that is operatively connected to the motor. The control system receives signals from the sensing system and is programmed to, in at least some instances:
a) determine using the signals when the display member support reaches one of the first and second ends of the track member, and
b) change the direction of rotation of the motor based on the determination made in step a).

In one embodiment, the sensing system includes a first sensor for detecting the first end of the track member and a second sensor for detecting the second end of the track member. The sensors may be Hall effect sensors.

In another embodiment, the moving display system includes an energy storage device for powering the control system and the motor. When the control system determines that the energy storage device has more than a selected amount of charge, the control system is programmed to carry out steps a) and b). When the control system determines that the energy storage device has less than the selected amount of charge, the control system is programmed to drive the display member support to a charging station and charge the energy storage device by connecting the energy storage device to an external source of power.

In another aspect, the invention is directed to a moving display system that includes a track member support, a track member held by the track member support, and having a first end and a second end, and a plurality of display member supports, including a first display member support and a second display member support. Each display member support includes a body, wherein the body is configured to hold a display member, a motor, and a wheel that is drivable by the motor to move the display member support along the track member, and a sensing system. A control system is associated with each display member support and is operatively connected to the motor. The control system receives signals from the sensing system, and is programmed to, in at least some instances:

a) determine using the signals when the display member support either reaches one of the first and second ends of the track member or comes into proximity to the other display member support, and

b) change the direction of the motor based on the determination made in step a).

In another aspect, the invention is directed to a moving display system, comprising: a track member support; a track member held by the track member support, and having a first end and a second end; a display member support, including a body, wherein the body is configured to hold a display member, a motor, a wheel, wherein the wheel is drivable by the motor to move the display member support along the track member, a sensing system including at least one sensor positioned for detecting the first and second ends of the track member, a slot extending through the body for receiving the track member, and a control system associated with the display member support, wherein the control system is operatively connected to the motor, wherein the control system receives signals from the sensing system and is programmed to, in at least some instances:

a) determine using the signals when the display member support reaches one of the first and second ends of the track member, and

b) change the direction of rotation of the motor based on the determination made in step a).

### BRIEF DESCRIPTION OF THE DRAWINGS

Reference is made to the attached drawings, in which:

FIG. 1 is an elevation view of a moving display system in accordance with an embodiment of the present invention;

FIG. 2 is a magnified perspective view of a display member support that is part of the moving display system shown in FIG. 1;

FIG. 3 is an end view of the display member support shown in FIG. 2;

FIG. 4 is a sectional plan view of a the display member support shown in FIG. 2;

FIG. 5 is an elevation view of a moving display system in accordance with another embodiment of the present invention;

FIG. 6 is a perspective view of a track structure that may be used with the moving display system instead of the track support shown in FIG. 1;

FIG. 7 is a side view of an alternative structure for charging an energy storage member in the moving display support shown in FIG. 2;

FIG. 8 is a side view of an alternative track structure that can be used as part of the moving display system shown in FIG. 1;

FIGS. 9a-9c are perspective and side views of an alternative display member support that can be used as part of the moving display system shown in FIG. 1,

FIG. 10 is a perspective view of an alternative display member that can be used as part of the moving display system shown in FIG. 1;

FIG. 11a is an elevation view of a moving display system in accordance with another embodiment of the present invention;

FIG. 11b is an end view of the display member support shown in FIG. 11a;

FIG. 12 is an elevation view of a moving display system in accordance with another embodiment of the present invention;

FIG. 13a is an elevation view of a moving display system in accordance with another embodiment of the present invention;

FIG. 13b-13c are end views of the display member support shown in FIG. 13a in the closed (FIG. 13b) and open (FIG. 13c) configurations;

FIG. 14a is an elevation view of a moving display system in accordance with another embodiment of the present invention; and,

FIG. 14b is a magnified elevation view of the second track support shown in FIG. 14a.

### DETAILED DESCRIPTION

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

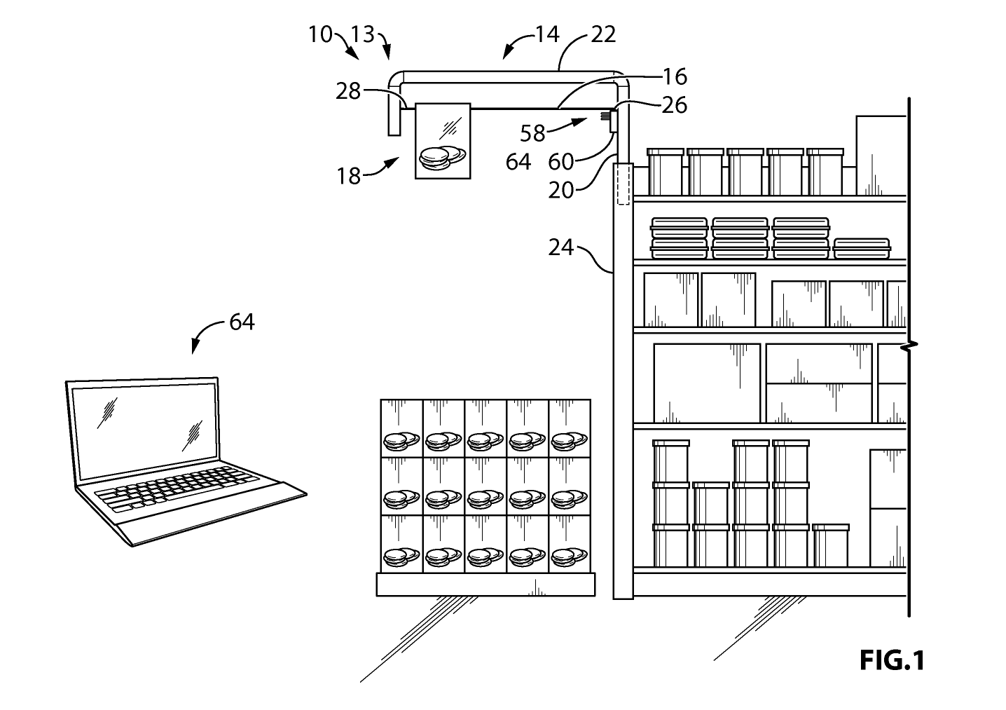

Reference is made to FIG. 1, which shows a moving display system 10 that may be used for displaying media on a display member 12 while moving it so as to make it more eye-catching to passersby. The moving display system 10 includes a track structure 13 which includes a track member support 14 and a track member 16, and a display member support 18 that is configured to hold the display member 12. The moving display system 10 may be positioned at the end of an aisle in a store or the like, or it may be provided in the form of an aisle violator (also referred to as an aisle invader) that extends into an aisle to be viewable by a store customer proceeding down the aisle.

The track member support 14 may have any suitable structure. For example the track member support 14 may be made up of a single metallic rod that has a base portion 20 and a track member holding portion 22. The base portion 20 is used for mounting the track member support 14 to some structure. For example in the embodiment shown in FIG. 1, the base portion 20 is sized to be mounted in and captured by a shelf support member 24 in a supermarket or department store. The track member holding portion 22 supports the track member 16.

The track member 16 supports the display member support 18 thereon and permits the movement of the display member support 18 thereacross. The track member 16 may have any suitable structure. For example, the track member 16 may be a flexible member or a semi-rigid member, such as a cable, a wire, a length of string, a length of rope of either stranded or solid natural or synthetic material. Alternatively the track member 16 may be a rigid member made from, for example, metal rod or tubing. As yet another alternative, the track member 16 may be a combination of flexible and rigid members. The track member 16 has a first end 26 and a second end 28.

The display member 12 may be any suitable type of display member 12. For example, the display member 12 may be made from paper or a polymeric material with a fixed printed image thereon. Alternatively, the display member 12 may be an electronic display member which can display still images and video. There are many suitable types of electronic display member that may be used for the display member 12, such as for example, an LCD screen, an LED screen, an OLED screen, a plasma screen or e-paper. An example of a display member 12 may be a tablet computer or similar device. The display member 12 may further include a plurality of individual lamps (e.g. LEDs) that can selectively be lit at selected times so as to draw attention to the display member 12 to passersby. As another alternative, the display member 12 may include an audio output device (e.g. a speaker) that can selectively be activated to draw attention to the display member 12 to passersby.

The display member support 18 moves across the track member 16 between the first and second ends 26 and 28. The display member support 18 may be completely untethered while moving on the track member 16, which provides a cleaner appearance for the display member support 18 as compared to tethered devices, and which also eliminates problems with tangling of power cables during movement of the display member support 18.

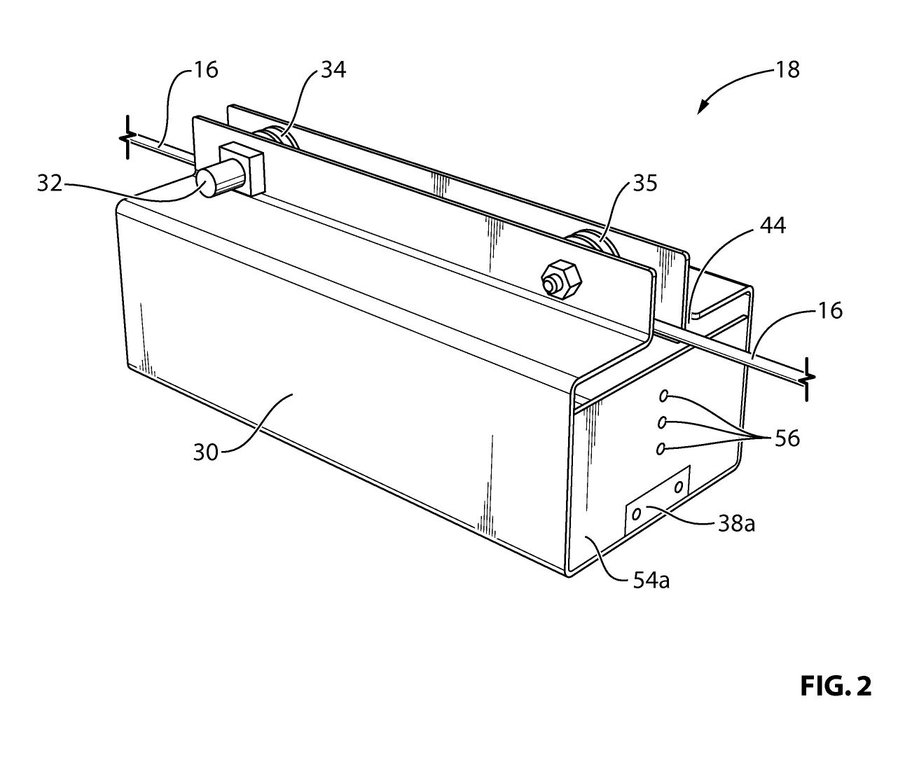

Referring to FIG. 2, the display member support 18 includes a housing or body 30, a motor 32 (which is, in the embodiment shown, a bidirectional motor), a first wheel 34 that is driven by the motor 32, a second wheel 35, a controller 36 for controlling the operation of the motor 32, a sensing system 38 that is used to assist the control system in determining the position of the display member support 18, and an energy storage device 40. The body 30 may be made from sheet metal or any other suitable (preferably lightweight) material and houses or supports the other components that make up the display member support 18. The motor 32 may be mounted to an exterior surface of the body 30 and has an output shaft that passes through an aperture in the body 30 and supports the first wheel 34 thereon. The first wheel 34 is therefore rotated by the motor 32, which drives the display member support 18 along the track member 16 in one direction or the other. The first wheel 34 and the second wheel 35 may have any suitable shape. Preferably they have a shape that helps to retain them on the track member 16. In the embodiment shown, the first and second wheels 34 and 35 each have a peripheral groove thereon which straddles the track member 16, which is a cable in the embodiment shown.

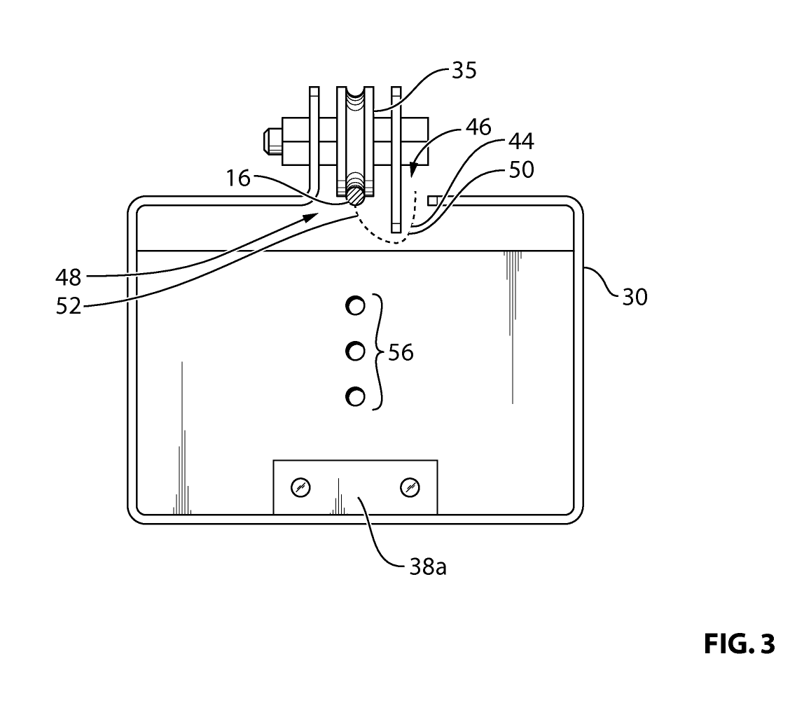

The first and second wheels 34 and 35 may be substantially in line so as to inhibit the display member support 18 from tipping in its direction of travel while accelerating or decelerating. The display member support 18 may have a center of gravity shown at Cg (FIG. 3) that is below (preferably directly below) the first and second wheels 34 and 35 so that the display member support 18 is stable while on the track member 16. The body 30 has a longitudinally extending slot 44 that is an installation path for the track member 16 when mounting the display member support 18 on the track member 16. Throughout this disclosure the slot 44 may be referred to as the installation path 44 where appropriate. The installation path 44 is more clearly shown in the form of a dashed line in FIG. 3. The installation path 44 extends generally laterally (albeit not directly laterally) from an opening 46 to an endpoint 48 which is at the undersides of the first and second wheel 34 and 35. As can be seen in FIG. 3, the installation path 44 includes a vertical drop shown at 50 and a vertical rise shown at 52 in the direction of travel of the track member 16 along the installation path 44 to the endpoint 48 (i.e. when installing the display member support 18 on the track member 16). In other words, as the track member 16 moves through the installation path, it initially drops down at least by some amount vertically relative to the display member support 18 and then near the end of the installation path 44 it rises by some amount vertically to reach the endpoint 48. As a result of this rise near the end of the path 44, the display member support 18 is inhibited from falling to the ground in the event that the wheels 34 and 35 leave the track member 16 inadvertently. Also, as can be seen in FIG. 3, the path 44 is blind in the sense that there is no other route for the track member 16 to leave the body 30 of the display member support 18, other than through the opening 46.

The sensing system 38 includes a first sensor 38a at a first longitudinal end 54a of the display member support 18 and a second sensor 38b at a second longitudinal end. The sensing system 38 detects when the display member support 18 has reached an end 26 or 28 of the track member 16, and sends a signal to the controller 36 notifying it of this event. The sensors 38a and 38b may be any suitable type of sensors, such as, for example, infra-red time-of-flight sensors. The sensors 38 and/or the controller 36 may be capable of adjusting the distance from the ends 26 and 28 at which the controller 36 reverses rotation of the motor 32. In one embodiment, the sensors 38a and 38b may be physically moved to desired positions on the body 30 of the display member support 18 so as to change the distance from the body 30 to the end 26 or 28 at which the controller 36 reverses the motor 32. In another embodiment, the adjustment of the distance may be carried out electronically. For example, if the sensors 38 are of the type that send a variable signal to the controller 36 that is indicative of the distance to the end 26 or 28, then the programming of the controller 36 may permit the selection of a new distance value at which it will reverse direction of the motor 32. Alternatively, if the sensors 38 only send a simple on/off type signal when an end 26 or 28 is detected, then the controller 36 can have an adjustable delay period before it reverses the motor 32 as part of its programming so it can vary the distance to the end 26 or 28 before reversal of the motor 32 is carried out.

While non-contact sensors are shown and described, it is alternatively possible to use contact sensors (e.g. limit switches) for the sensing system, which would contact the track member support 14 to generate a signal which would indicate to the controller 36 to reverse the motor 32.

In an alternative embodiment, the sensing system 38 may use different kinds of sensors and may operate differently. For example, the sensing system 38 may incorporate a single Hall effect sensor that counts rotations of the wheel 34, and the controller 36 may be programmed to determine when the display member support 18 has reached the end of the track member 16 after a selected number of rotations of the wheel 34.

The energy storage device 40 stores energy for powering the controller 36, the motor 32 and the sensing system 38 if need be. The energy storage device 40 may be any suitable type of device, such as, for example, a rechargeable battery. In embodiments wherein the energy storage device 40 is rechargeable, the display member support 18 may include a first connector 56 that mates with a second connector 58 on a charging station 60 that is at one of the ends 26 or 28 of the track member 16. In the embodiment shown, the first connector 56 is female and includes three apertures, while the second connector 58 is male and includes three prongs. It will be understood that the first connector could be male and the second connector could be female, or alternatively some other arrangement could be provided.

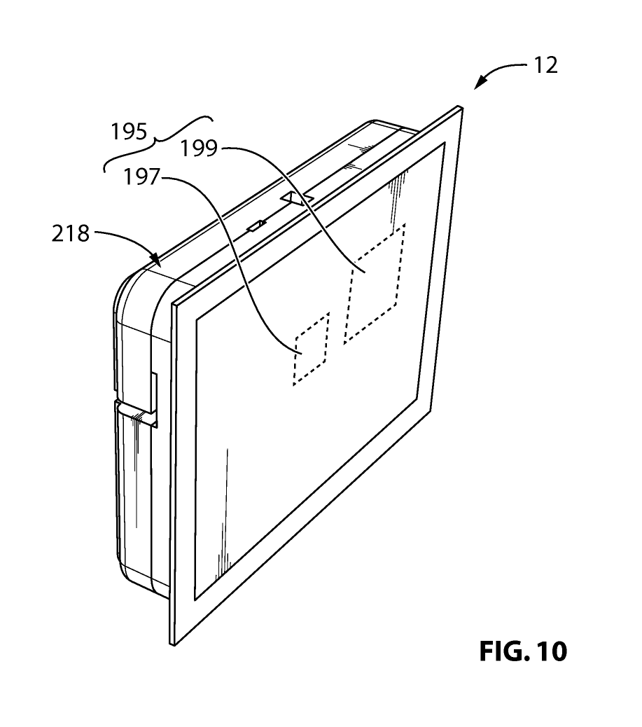

The controller 36 includes a processor 37 and a memory 39. The memory 39 stores data and program code used by the processor 37 to control the operation of the display member support 18. The controller 36 may be all or part of a control system that controls the operation of the assembly comprising the moving display support 18 and the display member 12. The control system may include the controller 36 and may further include an additional controller 195 shown in FIG. 10 (which contains a processor 197 and a memory 199) in embodiments wherein the display member 12 is an electronic display, such as is provided in a tablet computer. Alternatively, the control system may include only the controller 195 in some embodiments and this controller may be configured to control the operation of the display member support 18 (e.g. drive the motor 32 and receive input from the sensing system 38) via a wired connection to the motor 32 and the sensing system 38 or the like). Regardless of where the control system (or its individual one or more controllers) resides the control system may be said to be associated with the display member support 18 (and with the display member 12).

The controller 36 receives signals from the sensing system 38 and controls the operation of the motor 32 based on them, and based on other factors such as the state of charge of the energy storage device 40. The controller 36 may be programmed as follows: When the controller 36 determines that the energy storage device 40 has more than a selected amount of charge, the control system is programmed to:

a) determine using the signals when the display member support 18 reaches one of the first and second ends 26 and 28 of the track member 16, and
b) change the direction of rotation of the motor 32 based on the determination made in step a), so that the display member support 18 begins travelling along the track member 16 in the opposite direction, towards the other end 26 or 28. Thus, the display member support 18 may reciprocate from one end 26 or 28 to the other.

In an embodiment, the controller 36 may be programmed to cause the display member support 18 to appear to shake, so as to assist in getting the attention of passersby. To achieve this the controller 36 may repeatedly reciprocate the motor 32 at at least a selected frequency without translating significantly along the track member 16. In such an embodiment, the display member support 18 may include a motion sensor (not shown) to detect when a person is passing nearby which would be used to trigger the controller 36 to initiate the shaking of the display member support 18. After a shaking event has taken place, the controller 36 may be programmed to not permit another shaking event to take place for a selected period of time (e.g. 20 seconds).

When the controller 36 determines that the energy storage device 40 has less than the selected amount of charge, the controller 36 may be programmed to drive the display member support 18 to the charging station 60 and charge the energy storage device 40 by connecting the energy storage device 40 to an external source of power.

The controller 36 may determine whether the energy storage device 40 has sufficient charge by any suitable means. For example, the controller 36 may count the number of times that the display member support 18 has gone back and forth on the track member 16. This can be accomplished by counting the number of times that the sensors 38 have tripped. In an embodiment, for example, the controller 36 may be programmed to direct the display member support 18 to plug in to the charging station 60 to recharge the energy storage device 40 after the sensors 38 have tripped a selected number of times. The selected number of times may be adjustable. In an alternative embodiment, the controller 36 may determine whether the energy storage device 40 has sufficient charge by measuring the charge in the energy storage device 40. In yet another alternative embodiment, the controller 36 may determine whether the energy storage device has sufficient charge simply by measuring the amount of time that has elapsed since the previous charging cycle. In such an embodiment, the clock that is used to measure elapsed time would be considered the sensing system.

In order to charge the energy storage device 40, the controller 36 drives the motor 32 to rotate in the direction to bring the display member support 18 to the charging station 60 at which point the first and second connectors 56 and 58 engage each other. Upon engagement of the connectors 56 and 58, the controller 36 detects a voltage, at which point it continues to drive the motor 32 in an attempt to bring the first and second connectors 56 and 58 into full engagement with each other.

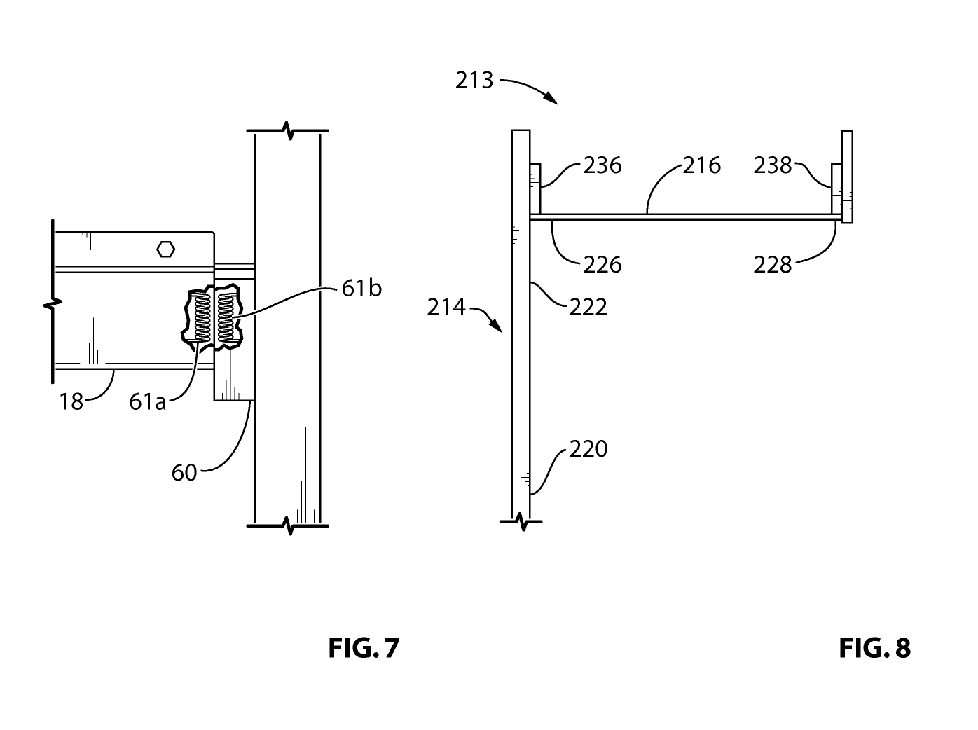

Instead of having first and second (male and female) connectors 56 and 58 that must mate together, the display member support 18 and the charging station 60 may be configured to charge the energy storage device 40 via magnetic inductance. In such an embodiment, the charging station 60 and the display member support 18 would each have an induction coil (which are individually identified as first induction coil 61a and second induction coil 61b in FIG. 7). When the display member support 18 requires charging, it would be driven towards the charging station 60 so that the induction coils 61a and 61b would be in sufficient proximity to one another so that energy transfer to the energy storage member 40 could take place. In the embodiment shown in FIG. 7, the display member support 18 could simply be driven until it contacts the charging station 60. This is a simpler arrangement in the sense that it would not require the level of alignment that is required for insertion of male connectors 56 into female connectors 58, and would also not require the motor 32 to drive the moving display support 18 with sufficient force to overcome the resistance that would exist to the insertion of the male connectors 56 into the female connectors 58.

When the moving display support 18 is brought to the charging station 60 (and in particular in embodiments where male and female connectors 56 and 58 are used), if by the end of a selected period of time (e.g. 8 seconds) the controller 36 does not detect a sufficiently high voltage, then the controller 36 may reverse the motor 32 so as to bring the display member support 18 out of engagement with the charging station 60 and may then try again, reversing the motor 32 again to drive the display member support 18 back into engagement with the charging station 60. If after a selected number of tries, the controller 36 does not measure a sufficient voltage, then the controller 36 may determine that there is a problem and may take some suitable action. For example, the controller 36 may signal that a problem exists by illuminating a lamp (e.g. an LED) on the display member support 18 so as to indicate to store employees that a problem exists. Alternatively or additionally, the display member support 18 may be equipped with a wireless communication device 62 that is used by the controller 36 to send a wireless signal to a remote device 64 (FIG. 1) that there is a problem. The wireless communication device 62 may be any suitable type of device. For example, if the remote device 64 is located within the same store in which the moving display system 10 is installed, then the wireless communication device 62 may be a Wi-Fi network adapter, a Bluetooth adapter. In the event that the display member 12 is a tablet computer, it may be equipped with a Wi-Fi network adapter so as to communicate with a remote device 64 and may thus be considered to possess the wireless communication device 62 instead of the display member support 18. Alternatively, if the remote device 64 is located in some other place (e.g. in a different building entirely, in the same city, or in a different city for example), then the wireless communications device 62 may be a cellular network adapter. As yet another alternative, the wireless communications device 62 may communicate with a base station over a Wi-Fi or similar network and that base station may communicate with a remote device 64 over the internet or some other means.

In embodiments wherein the display member 12 includes Wi-Fi or other wireless communications capability, it may be connected to the controller 36 on the display member support 18 by means of a physical connection, such as a USB connection to permit communication of data and commands between the display member support 18 and the remote device 64.

By signaling the remote device 64 that there is a problem, a service person can come to correct the problem quickly, so that the system 10 is not left inoperative for a long period of time.

In embodiments wherein the display member 12 is an electronic display and includes its own controller 195 (FIG. 10), the controller 195 may be responsible for updating the images on the display member 12. In some embodiments, each of the display member support 18 and the display member 12 may be equipped with wireless network adaptors 62 that communication with different remote devices 64 for handling the operation of the display member support 18 and the display member 12 separately.

In addition to indicating to a remote device 64 that a charging problem has occurred, the controller 36 can use the wireless communications device 62 to indicate that other types of problem have occurred, such as a situation where the energy storage device 40 has so little charge that the display member support 18 cannot be driven to the charging station 60, or a situation where the motor 32 is inoperative for some reason.

In addition to using the wireless communications device 62 to indicate to a remote device 64 that a problem has occurred, the wireless communications device 62 can be used to receive commands from the remote device 64. For example, a revised control program may be uploaded to the controller 36 in order to change how the controller 36 operates the display member support 18. As an example, for a particular type of product, it may be desired to replace a control program in which the display member support 18 simply moved back and forth repeatedly between the ends 26 and 28 of the track member 16, with a program wherein the controller 36 causes the display member support 18 to shake at some regular interval to attract attention. Additionally or alternatively, in embodiments wherein the display member 12 is an electronic display member, the wireless communications device 62 may be used to receive new media to display on the display member 12. For example, a store may use the moving display system 10 to display images of a particular brand of cookies for a selected period of time (e.g. a week). At some point a decision may be made to push the sales of a different product (e.g. cereal), and so a cereal image may be uploaded to the control system memory for display on the display member 12.

In embodiments where a wireless communications device 62 is provided, it would be possible for the wireless communications device 62 to be used to communicate in a limited way with personal devices, such as smartphones, tablet computers or the like. Optionally, the controller 36 could permit control of its programming only to authorized persons (e.g. service personnel), or in a limited way to passersby. For example, it could act on commands from passersby or could communicate with passersby by shaking, emitting sounds, displaying particular messages on the display member 12, or any other suitable way. Additionally or alternatively, the device 62 may transmit information regarding the advertised product as well as electronic coupons (or web links thereto), loyalty points or the like to passersby when they initiate communication with the device 62 so as to promote such communication.

In an embodiment it is possible to provide one or more non-powered display member supports that may be connected to the powered display member support 18, and which may be used to hold separate display members, or a portion of a large display member that is in part held by the powered display member support 18. In such an embodiment care is to be taken to ensure that the sensing system 38 is not obstructed by the non-powered display member supports, or that electrical current can be routed through to sensors on the non-powered display member supports that would then be part of the sensing system 38.

In an embodiment, the charging station 60 draws power from the electrical power supply in the location in which it is installed (e.g. AC wall power, or in other words, the electrical power that is supplied to the store from the power grid). In an alternative embodiment, it is possible for the moving display system 10 to include a different arrangement for supplying power to the display member support 18 than that shown in FIG. 1. For example, the moving display system 10 could optionally include a photovoltaic panel (not shown) to generate electrical power, which is stored in a charging station energy storage device (not shown). The charging station 60 could still be connected to the in-store power supply, but could be programmed only to draw power from it when there is no charge remaining in its own energy storage device. This would reduce the operating costs associated with the moving display system 10.

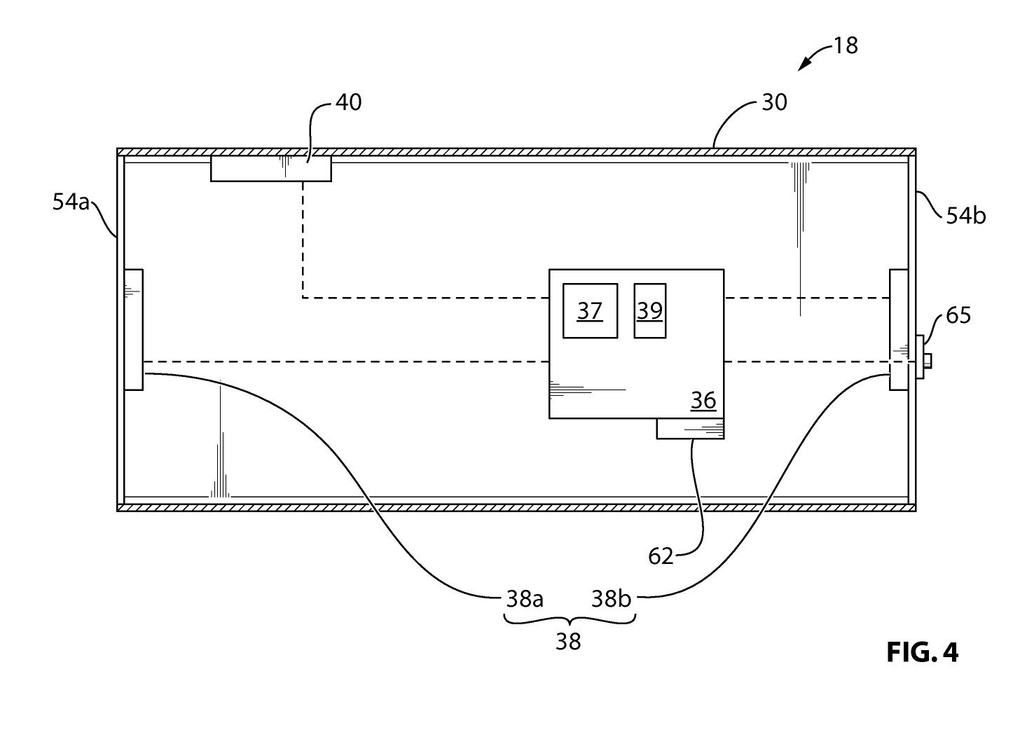

In an embodiment, as shown in FIG. 4, the display member support 18 includes a master switch 65 that is used to manually turn on and off the display member support 18.

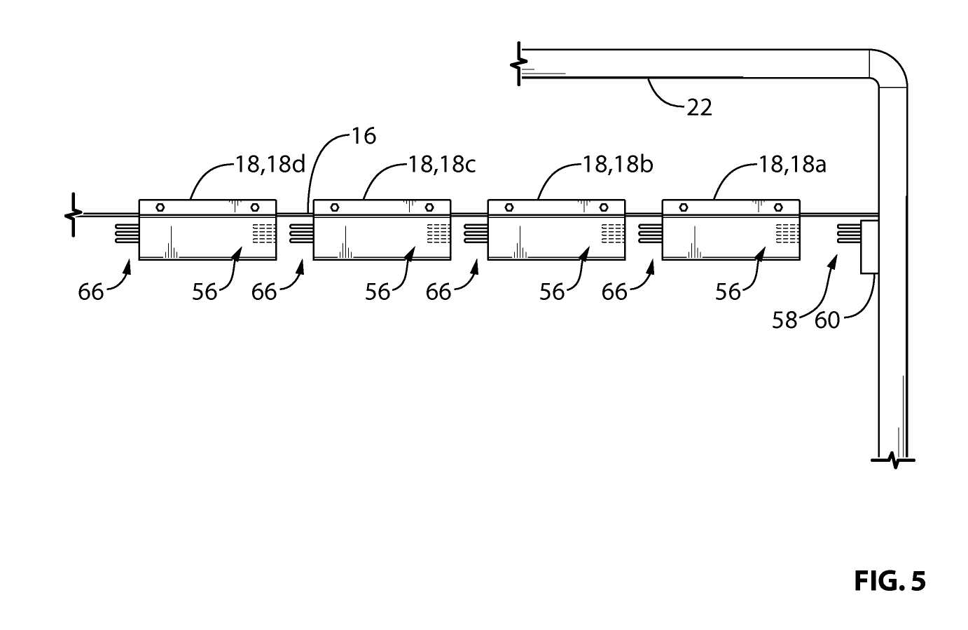

In yet another embodiment, the display member support 18 may be a first display member support 18a and the moving display system 10 may include additional powered display member supports, as shown at 18a, 18b and 18c in FIG. 5. In the embodiment shown in FIG. 5, each display member support 18 may be equipped identically. It can be seen in FIG. 5a, that only the first display member support 18a can connect directly to the charging station 60. In order to permit all the display member supports 18 to be charged, each display member support 18 may include a secondary connector 66 on its other longitudinal end, which is electrically connected to the primary connector 56 on the first longitudinal end (which is the end that faces the charging station 60). Thus, when the first display member support 18a plugs into the charging station 60, the second display member support 18b can plug its primary connector 56 into the secondary connector 66 of the first display member support 18a. Similarly, the third display member support 18c can plug its primary connector 56 into the secondary connector 58 of the second display member support 18b, and so on. In this way, all the display member supports 18 can be connected to the charging station 60. Preferably, the connections are in parallel so that if there is a problem with the controller 36 or the energy storage device 40 of one of the display member supports 18 the other display member supports 18 can still recharge.

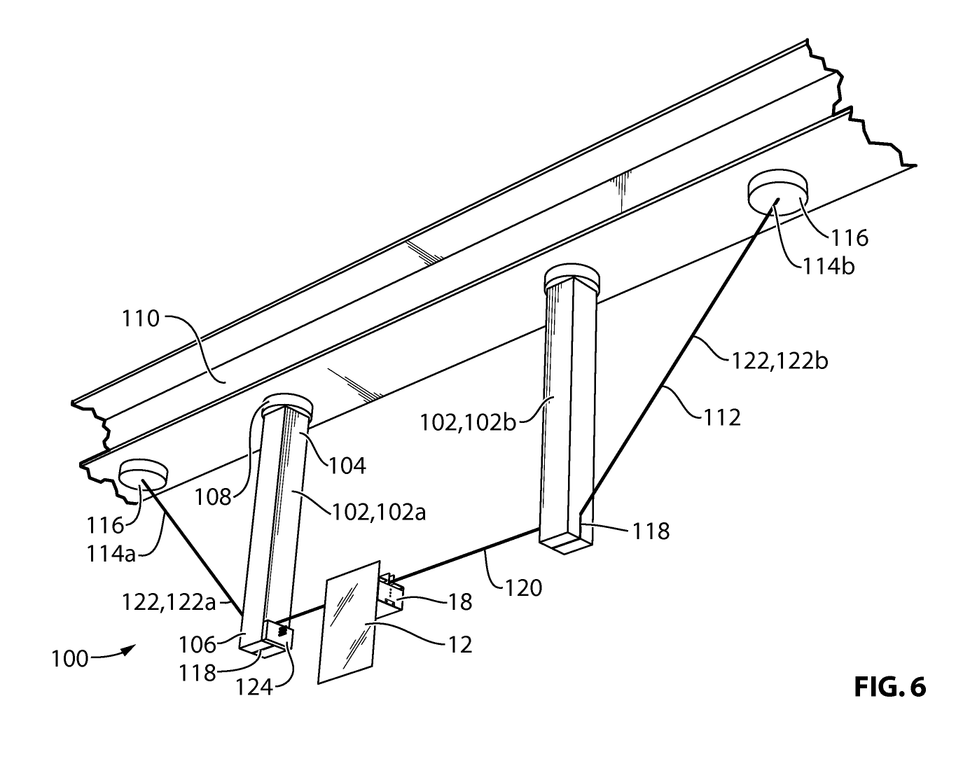

Reference is made to FIG. 6, which shows an alternative track structure 100 that can be used as part of the moving display system 10 instead of the track structure 13. The track structure 100 includes first and second posts 102 shown individually at 102a and 102b. Each post 102 has a mounting end 104, (which may be referred to as a post mounting end), and a free end 106 (which may be referred to as a post free end). At the post mounting end 104, the post 102 may have a magnet 108 (which may be referred to as a post magnet) which holds the post 102 to a metal support member (shown at 110), such as a steel joist from the building or structure in which the moving display system 10 is to be installed. The first and second posts 102 are positioned a selected distance apart from each other. A cable 112 has a first end 114a and a second end 114b, and has a magnet 116 (which may be referred to as a cable magnet) that holds the end 114a or 114b of the cable 112 to the metal support member 110. The cable 112 extends from its two ends 114a and 114b (which may be referred to as cable mounting ends 114a and 114b) to the free ends 106 of the posts 102 and then across the distance between the two posts 102. The posts 102 may have slots 118 at their free ends 106 for capturing the cable 112 to ensure that the cable 112 does not come off the posts 102 inadvertently. The cable magnets 116 are sufficiently strong that the span of cable 112 between the posts 102 can be made taut. It is this span, which is shown at 120 that constitutes the track member. The other spans of cable, shown at 122 (122a and 122b individually), together with the posts 102, make up the track member support. A charging station 124 may be mounted to the free end 106 of one of the posts 102, and may be plugged in to a power source such as an electrical outlet from the building in which the moving display system 10 is being installed. The charging station 124 may be connected to by the display member support 18 in similar manner to the charging station 60.

In an alternative embodiment the cable 112 may be replaced with three separate cables, each corresponding to one of the aforementioned spans 120 and 122.

The track structure 100 is advantageous in situations where it is desirable to set up the moving display system 10 on a temporary basis, such as for use at a trade show. The track structure 100 can be installed quickly, and can be torn down quickly. Additionally, in its torn down state, the track structure 100 occupies a very small volume and is easily transported from location to location.

While the moving display system 10 may be used for advertising purposes, as shown in the example in FIG. 1, it is alternatively or additionally possible to use the moving display system 10 for the purpose of communicating information to passersby, such as information regarding store hours, information regarding which check-out line is open, information regarding the nearest exit in an emergency, the location of certain points of interest in the store such as washrooms, a bank machine or the like. The moving display system 10 may be situated in places other than a store, such as for example, in a mall, at a trade show, at an event such as a fair, or other locations.

In particular, by providing the display member support with only two wheels that are substantially in-line with each other, with an on-board energy storage device, and with two proximity sensors, preferably but not necessarily non-contact sensors, each configured for detecting one end of the track member, the display member support may be made lightweight, reliable, while being inexpensive and while using very simple programming.

Reference is made to FIG. 8, which shows another embodiment of a track structure shown at 213. The track structure 213 includes a track member support 214 and a track member 216. The track member support 214 is a single metallic rod that has a base portion 220 for mounting the track member support 214 to some structure such as a shelf support member 24 (FIG. 1), and a track member holding portion 222 for holding the track member 216. The base portion 220 may be provided to be magnetic so that it adheres securely to the shelf support member 24 without the need for fasteners such as bolts and the like. The base portion 20 in the track structure 13 shown in FIG. 1 may also be provided to be magnetic to similar benefit. Alternatively, or additionally, bolts may be provided for positively securing the base portion 20 or 220 to the shelf support member 24.

The display member support 18 (FIG. 2) may be modified to have an opening 46 that is suitably sized for the track member 216.

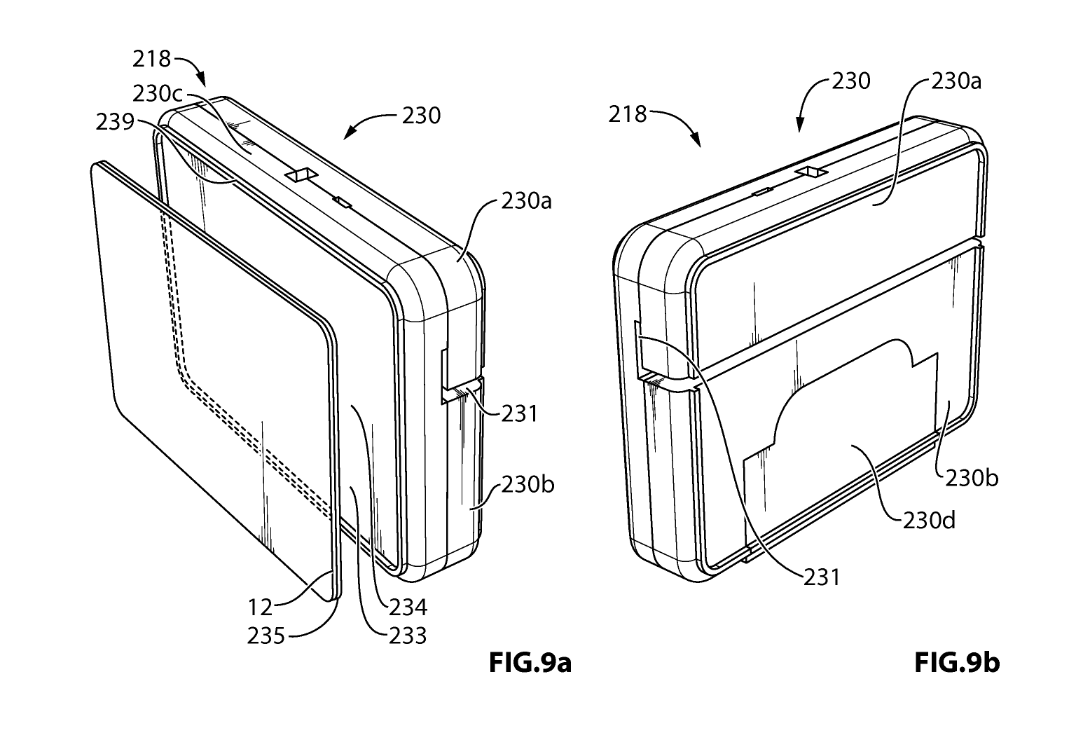

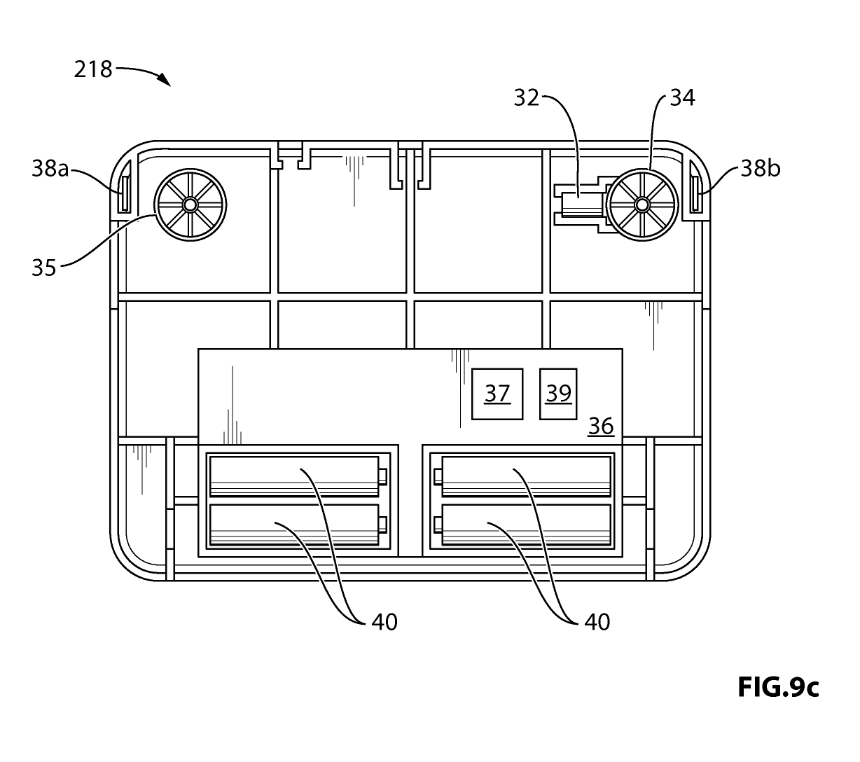

Reference is made to FIGS. 9a, 9b and 9c which show a display member support 218. The display member support 218 may be similar to the display member support 18 (FIG. 2), but may have a body or housing 230 that is molded from a polymeric material, such as nylon or ABS. The housing 230 has a slot 231 therein that provides a path for a track member such as track member 16 (or track member 216 if slot 231 was made sufficiently wide. The slot 231 is formed by a spacing between first and second housing elements 230a and 230b and then by a spacing between second and third housing elements 230b and 230c. The slot 231 may be sized to slidably but snuggly receive the track member 216 so as to guide the track member 16 to the correct spot to engage pulleys 34 and 35. As shown in FIG. 9b, an additional housing element 230d is provided, which is a cover for a battery compartment that holds four energy storage devices 40 (e.g. batteries).

Referring to FIG. 9a, the housing element 230a has a display member holding area 233 that is defined by a raised lip 239. In the embodiment shown the display member holding area 233 is configured to frame all four sides of a rectangular display member 12, however it is alternatively possible to only frame the top and left and right sides of a display member 12 so as to permit the installation of a display member 12 that is taller than the display member support 218. In other words, by framing only the top and left and right sides of the display member 12, the display member 12 can be sized so that a portion of it hangs down from the display member support 18. In an embodiment, the display member 12 may be held to the display member support 218 by means of magnetic attraction. For example, the surface of the display member holding area 233 may have a magnetically attractive material 234 thereon (e.g. made from steel or some other ferromagnetic material) so as to permit the adherence of a magnet 235 optionally provided on the back of the display member 12 thereto. In an embodiment, the magnetically attractive material 234 may be in the form of a ferromagnetic coating that is applied to the surface of the holding area 233. The coating may be applied as a paint, or as a sheet with adhesive on one side. Alternatively, the housing element 230c may be made from a ferromagnetic material.

The magnet 235 provided on the back of the display member 12 may be any suitable type of magnet such as a flexible, flat Halbach array type of magnet formed from a mixture of ferric oxide and a plastic binder, similar to that which is used to manufacture flexible refrigerator magnets. Alternatively, any other type of magnet may be used, such as a rigid ceramic magnet, or a plurality thereof. The display member 12 and the magnet 235 may be adhered together using any suitable adhesive.

In an alternative embodiment, the magnetically attractive material 234 may be a magnet (e.g. a flexible, flat Halbach array type of magnet) that is arranged to be attracted to the magnet 235 at the back of the display member 12.

In yet another embodiment, the magnetically attractive material 234 may be a magnet and the magnet 235 on the display member 12 may instead be a ferromagnetic element or some other type of magnetically attractive material 234. Thus, a first magnetically attractive material is provided on the display member support 218 and a second magnetically attractive material is provided on the display member 12, wherein at least one of the magnetically attractive materials is magnetic.

The display member 12 may be any suitable type of display member and may be made from a polymeric material or some other suitable material.

While a display member 12 is not shown on the side of the display member support 218 with the slot 231 it is possible to provide room for a display member 12 on that side. Thus advertising may be provided on both sides of the display member support 218.

Referring to FIG. 9c, which shows the display member support 218 with the first, second and fourth housing elements 230a, 230b and 230d removed. As can be seen in FIG. 9c, the controller 36, the sensors 38, the motor 32, the pulleys 34 and 35 are all provided in the housing 230. The motor 32 may drive the pulley 34 by any suitable means, such as by a worm (not shown) on the output shaft of the motor 32 and a worm gear (not shown) on the pulley 34 that engages the worm.

It will be noted that the sensor 38a and 38b may be Hall-effect sensors and thus may be positioned within the housing 230 while still being able to sense a nearby magnetic field outside the housing 230. The track structure 13 or 213 may, for example, include first and second magnets positioned at the ends 26, 226 and 28, 228 of the track member 16, 216. Magnets are shown at 236 and 238 in FIG. 8. As the display member support 218 reaches one end 26, 226 or the other 28, 228 of the track member 16, 216, one or the other of the Hall-effect sensors 38a or 38b will be tripped by the associated magnet 236 or 238 through the wall of the housing 230. Thus there need not be an opening in the housing 230 as there would be for an optical sensor, for example. Where Hall-effect sensors are used as sensors 38a and 38b, care may need to be taken to ensure that stray magnetic fields from other sources, such as the display member 12 or the base portion 20 of the track structure 213 do not inadvertently interfere with the operation of these sensors 38a and 38b.

The Hall-effect sensors 38a and 38b may also be provided on the display support member 18 shown in FIGS. 1-4.

While on-board power storage devices 40 are shown in the embodiments shown in FIGS. 4 and 9c, the display member support 18, 218 need not include them. For example, power may be provided from an external source (e.g. AC wall power) and may be routed along the track member support 22. A ribbon cable similar to the ribbon cables used on the moving print heads in certain types of printer may extend from a point on the track member support 22 to the display member support 18, 218. Where AC power is drawn from external source, an AC-DC converter (not shown) may be needed if the controller 36 and the components such as the motor 32 are configured to operate on DC power.

As shown in FIGS. 9a-9c the display support member 218 may not include a first connector 56 that is shown in FIGS. 1-4. Instead the panel 230d is removable and the energy storage devices 40 (e.g. batteries) may be removable and replaceable. The devices 40 that were removed may be rechargeable batteries that can be recharged outside of the display support member 218 or alternatively they could be disposable. Alternatively, a connector (not shown) may be provided that permits the entire display member support 218 to be removed and plugged into a wall-charger away from the track structure 13 or 213 for charging the energy storage devices 40. In such a scenario, it is possible for a replacement display member support 218 to be provided for use while the first display member support 218 is charging.

While the display member 12 has been shown to be a planar display member, it is alternatively possible for the display member 12 to be a three dimensional shape. In an embodiment, the display member 12 may be the product that is being advertised, or it may be an enlarged, three dimensional reproduction of the product that is being advertised.

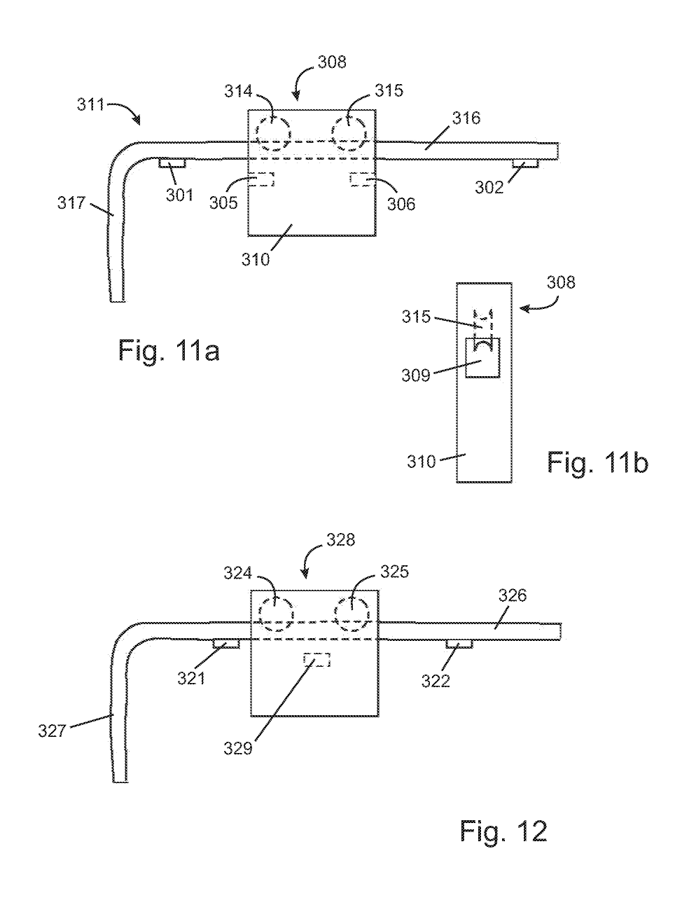

Reference is made to FIGS. 11a and 11b which show a moving display system in accordance with another embodiment of the present invention having a display support member 308 supported on a track structure 311. The track structure is a single piece of bar stock, preferably round or square, preferably being bent at an angle, for example at an angle of about 90-degrees. A track member 316 is formed of one arm of the track structure while a track support 317 is formed of the other arm of the track structure. Where the track structure is to be mounted on a horizontal surface, the track structure may be a single straight piece of bar stock with one portion along its length a track support portion and the another portion a track member. The track support may be mounted on a support surface such as a display case, a wall, a counter, or the like.

The display support member 308 comprises a housing or body 310 containing collinear first and second wheels 314,315 that travel on the track member 316 thereby moving the display support member along the track member. As shown more clearly in FIG. 11b, the body of the display support member comprises a longitudinally extending slot 309 beneath the first and second wheels, the slot of a size to receive the track member so that the wheels may travel freely on the track member without slipping off the track member. The display support member is mounted on the track member by simply feeding the track member through the longitudinally extending slot.

In operation, the display support member moves along the track by virtue of a bidirectional motor (not shown) that drives at least one of the wheels. The motor is controlled by a controller (not shown) that receives signals from first and second Hall effect sensors 305,306 contained in the body 310 of the display support member. The first Hall effect sensor 305 is positioned at a first end of the body 310 beneath the slot 309, while the second Hall effect sensor 306 is positioned at a second end of the body 310 beneath the slot 309. As the display support member travels to the left in FIG. 11a, the first Hall effect sensor reaches a first magnet 301 positioned on the underside of the track member 316 proximal a first end of the track member. The magnetic field of the magnet causes the first Hall sensor to send a signal to the controller, whereupon the controller sends a signal to the motor to change its direction thereby causing the display support member to start moving in the rightward direction in FIG. 11a. The display support member will then move toward a second end of the track member proximal to which is a second magnet 302 positioned on the underside of the track member. When the second Hall sensor 306 reaches the second magnet 302, the magnetic field of the second magnet causes the second Hall sensor to send a signal to the controller, whereupon the controller sends a signal to the motor to change its direction thereby causing the display support member to start moving back in the leftward direction in FIG. 11a.

Reference is made to FIG. 12 which shows a moving display system having a display support member 328 comprising a body 320 and first and second wheels 324,325 travelling on track member 326 supported by track support 327 in a similar manner as for the embodiment shown in FIGS. 11a and 11b. The embodiment shown in FIG. 12 differs from that shown in FIGS. 11a and 11b in that the display support member 328 contains only one Hall effect sensor 329 positioned in the middle of body 320 beneath the longitudinally extending slot. For this reason, first and second magnets 321,322 are positioned closer together and farther away from the ends of the track member 326 by amounts to compensate for the distances from the Hall effect sensor 329 to each end of the body 320. This is to prevent the display support member 328 from sliding off the end of track member 326 and from striking the track support 327. The embodiment shown in FIG. 12 may also comprise a motor and controller as described for FIG. 11.

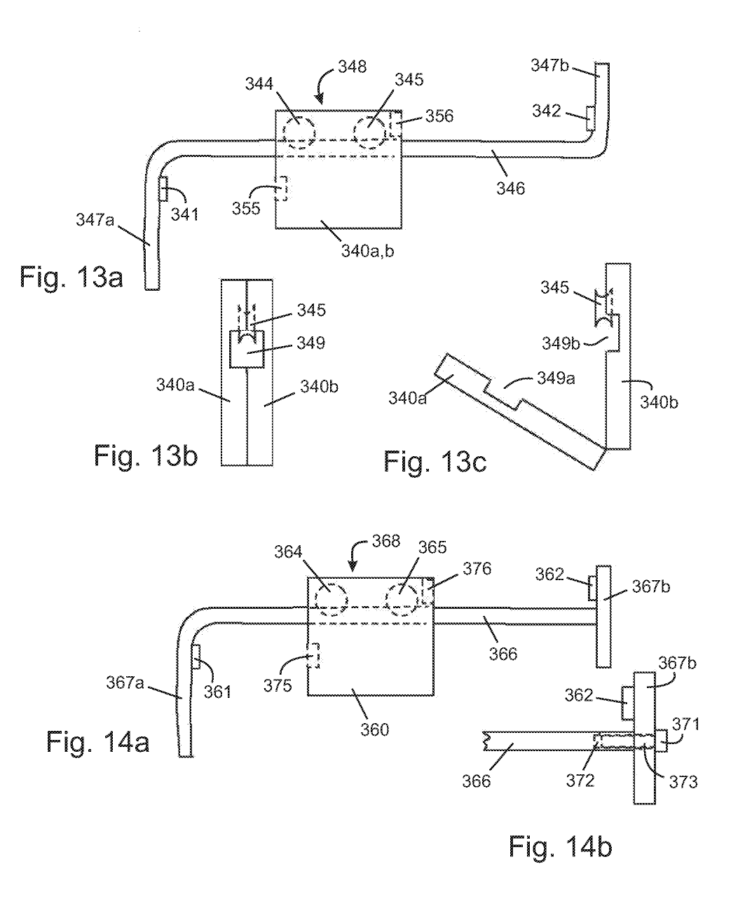

Reference is made to FIGS. 13a-13c which show a moving display system having a display support member 348 comprising a body 340a,b and first and second wheels 344,345 travelling on track member 346 supported by first and second track supports 347a,347b. The track support members and the track member may be formed from a single piece of bar stock with a first end bent down by about 90-degrees to form the first track support 347a and a second end bent up by about 90 degrees to form the second track support 347b. This arrangement prevents the display support member 348 from sliding off either end, thereby reducing the possibility of accident or theft. Alternatively, both track supports may bent in the same direction, whether up or down.

Magnets and Hall effect sensors may be positioned on the track member as described for FIG. 11, however, first and second magnets 341,342 may instead be positioned as shown in FIG. 13a on the first and second track supports 347a,347b, respectively, facing towards the display support member 348. First and second Hall effect sensors 355,356 may then be positioned at first and second ends of the display support member 348 such that they are adjacent the first and second magnets 341,342, respectively, when the display support member 348 is at the first and second ends, respectively, of the track member. Thus, the first Hall sensor 355 is located proximal the first end of the display support member 348 positioned beneath longitudinally extending slot 349, while the second Hall effect sensor 356 is located proximal the second end of the display support member 348 positioned above the longitudinally extending slot 349. The embodiment shown in FIGS. 13a-13c may also comprise a motor and controller as described for FIG. 11.

With reference to FIGS. 13b and 13c, because the display support member 348 cannot simply slide on to the track member 346, the display support member 348 may have a clamshell structure in which first and second body halves 340a,340b are hingedly connected at a bottom of the body 340a,b parallel to the longitudinally extending slot 349 so that the two halves may be together at a top of the body in a closed configuration as seen in FIG. 13b, or separated at the top of the body in an open configuration as best seen in FIG. 13c. This permits mounting the display support member 348 on the track member 346, which is received within first and second slot halves 349a,349b in the body halves 340a and 340b, respectively. Thus, the clamshell may be closed over the track member 346 such that the track member extends through the longitudinally extending slot 349 with the wheels 344,345 travelling on the track member. A closure device (not shown) secures the two body halves together and the body halves may be locked together for extra security.

Reference is made to FIGS. 14a-14b which show a moving display system having a display support member 368 comprising a body 360 and first and second wheels 364,365 travelling on track member 366 supported by first and second track supports 367a, 367b. One or both of the track supports may employ a bolt and thread structure to secure the track support to the track member. In FIG. 14a, the moving display system is shown with the second track support 367b utilizing such a bolt and thread structure. Details of the thread and bolt structure are best seen in FIG. 14b where track member 366 comprises a threaded aperture 372 into which a bolt 371 can be screwed. The second track support 367b comprises an unthreaded aperture 372 through which the bolt 371 may extend thereby securing the second track support 367b to the track member 366 when the bolt is fully tightened. Such an arrangement permits the use of a display support member without a clamshell structure while obtaining the security benefits of the embodiment shown in FIG. 13. Magnets and Hall effect sensors may be positioned as in any of the embodiments described in FIGS. 11-13. However, in FIG. 14a, first and second magnets 361,362 and first and second Hall sensors 375,376 are positioned in a manner like in FIG. 13a. The embodiment shown in FIG. 14 may also comprise a motor and controller as described for FIG. 11.

FIGS. 11-14 show embodiments that are less expensive to produce than other embodiments described herein.

While the above description constitutes a plurality of embodiments of the present invention, it will be appreciated that the present invention is susceptible to further modification and change without departing from the fair meaning of the accompanying claims.

1. A moving display system, comprising:
a track member support;
a track member held by the track member support, and having a first end and a second end;
a display member support, including
a body, wherein the body is configured to hold a display member,
a motor,
a wheel, wherein the wheel is drivable by the motor to move the display member support along the track member,
a sensing system including at least one sensor positioned for detecting the first and second ends of the track member,
a slot extending through the body for receiving the track member, and
a control system associated with the display member support, wherein the control system is operatively connected to the motor, wherein the control system receives signals from the sensing system and is programmed to, in at least some instances:
a) determine using the signals when the display member support reaches one of the first and second ends of the track member, and
b) change the direction of rotation of the motor based on the determination made in step a).

2. The moving display system as claimed in claim 1, wherein the track member is a length of bar stock.

3. The moving display system as claimed in claim 2, wherein the track member and track member support are formed from a single piece of bar stock.

4. The moving display system as claimed in claim 3, wherein the track member support is bent away from the track member at an angle.

5. The moving display system as claimed in claim 4, wherein the angle is about 90 degrees.

6-21. (canceled)

22. A moving display system, comprising:
a track member having a first and second end, the track member held by a first track member support at the first end, the track member and first track member support formed from a single piece of bar stock, the first track member support bent away from the track member at an angle,
a second track member support holding the track member at the second end, the second track member support formed from the same piece of bar stock as the track member and bent away from the track member at an angle or the second track member support comprising a track support disposed at an angle from the track member and comprising an unthreaded aperture through which a bolt extends to secure the track support to a threaded aperture in the second end of the track member for receiving the bolt,
a display member support, including
a body, wherein the body is configured to hold a display member,
a motor,
a wheel, wherein the wheel is drivable by the motor to move the display member support along the track member,
a sensing system including at least one sensor positioned for detecting the first and second ends of the track member,
a closed slot extending through the body for receiving the track member, and
a control system associated with the display member support, wherein the control system is operatively connected to the motor, wherein the control system receives signals from the sensing system and is programmed to, in at least some instances:
a) determine using the signals when the display member support reaches one of the first and second ends of the track member, and
b) change the direction of rotation of the motor based on the determination made in step a).

23. The moving display system as claimed in claim 22, wherein all of the angles are about 90 degrees.

24. The moving display system as claimed in claim 22, wherein the body comprises two body halves hingedly attached along one edge parallel to the slot to permit opening of the body to permit receiving of the track member in the slot.

25. The moving display system as claimed in claim 22, wherein the sensing system comprises at least one Hall effect sensor that produces a signal upon reaching a magnet positioned proximal the first or second end of the track member.

26. The moving display system as claimed in claim 25, wherein first and second magnets are positioned proximal the first and second ends of the track member.

27. The moving display system as claimed in claim 26, wherein at least one of the magnets is positioned on the track member.

28. The moving display system as claimed in claim 26, wherein at least one of the magnets is positioned on the track support member.

29. The moving display system as claimed in claim 25, wherein the at least one Hall effect sensor is one Hall effect sensor positioned proximal a middle of the body.

30. The moving display system as claimed in claim 25, wherein the at least one Hall effect sensor is two Hall effect sensors positioned proximal first and second longitudinal ends of the body.

31. The moving display system as claimed in claim 22, wherein the wheel is a first wheel and wherein the display support member further includes a second wheel that is substantially in-line with the first wheel and wherein the display support member has a center of gravity that is below the first and second wheels.

32. A moving display system as claimed in claim 22, wherein the slot passes all the way through the body longitudinally, thereby defining a generally laterally extending installation path for the track member when mounting the display support member on the track member, wherein the installation path extends from an opening in the exterior of the body to an endpoint on an underside of the wheel.

33. The moving display system as claimed in claim 22, wherein the display member is a printed member.

34. The moving display system as claimed in claim 22, wherein the display member is an electronic display.

35. The moving display system as claimed in claim 34, wherein the display member support includes a wireless communication device and wherein the control system is programmed to receive commands from a remote device and to change media displayed on the electronic display based on the commands.

36. The moving display system as claimed in claim 35, wherein the wireless communication device includes a cellular communication device.

37. The moving display system as claimed in claim 35, wherein the wireless communication device includes a Wi-Fi device.
